(19) United States
(12) Patent Application Publication
(10) Pub. No.: US 2015/0226317 A1
(43) Pub. Date: Aug. 13, 2015

(54) MONO-STABLE ROTARY TRANSMISSION SELECTOR

(71) Applicant: GM GLOBAL TECHNOLOGY OPERATIONS LLC, Detroit, MI (US)

(72) Inventors: David A. Provenza, Shelby Township, MI (US); William A. Arnold, Berkley, MI (US); Michael A. Van Camp, Swartz Creek, MI (US); Orson S. Wang, Novi, MI (US)

(73) Assignee: GM GLOBAL TECHNOLOGY OPERATIONS LLC, Detroit, MI (US)

(21) Appl. No.: 14/179,591

(22) Filed: Feb. 13, 2014

(51) Int. Cl. F16H 59/08; G05G 5/00

(52) U.S. Cl. CPC F16H 59/08; G05G 5/005; F16H 2059/081

(57) ABSTRACT

A mode selection system for switching between different operating modes of a transmission includes a rotary transmission selector for switching between a neutral mode, a forward drive mode, and a reverse drive mode. A park selector for selecting a park mode of the transmission is separate and remotely located from the rotary transmission selector. The rotary transmission selector is axially moveable along a central axis between a reference position and an axially depressed position. The rotary transmission selector is rotatable about the central axis. However, the rotary transmission selector is only rotatable about the central axis when depressed into the axially depressed position. The rotary transmission selector is mono-stable, and automatically returns to a reference position when released.

### TECHNICAL FIELD

The invention generally relates to mode selection system for switching between a plurality of different operating modes of a transmission, and more specifically to a mode selection system that includes a rotary transmission selector dial.

### BACKGROUND

Vehicles include a transmission mode selector, commonly referred to as a gear selector, for switching between different operating modes of the transmission. The different operating modes of the transmission may include, but are not limited to, a park mode, a forward drive mode, a reverse drive mode, and a neutral mode. The transmission mode selector controls the transmission to switch between the different operating modes. The transmission mode selector may include a shift-by-wire system, which uses an electronic controller disposed between the transmission mode selector and the transmission being controlled. In shift-by-wire systems, the transmission mode selector may include a rotary transmission selector, which typically includes a dial that the driver rotates to switch between the different operating modes of the transmission.

### SUMMARY

A vehicle is provided. The vehicle includes a rotary transmission selector for switching a transmission between a plurality of different operating modes. The rotary transmission selector is axially moveable along a central axis between a reference position and an axially depressed position. The rotary transmission selector is rotatable about the central axis. However, the rotary transmission selector is only rotatable about the central axis when disposed in the axially depressed position.

A mode selection system for switching between a plurality of different operating modes of a transmission is also provided. The mode selection system includes a rotary transmission selector for switching between a neutral mode, a forward drive mode, and a reverse drive mode of the transmission. The mode selection system further includes a park selector for selecting a park mode of the transmission. The park selector is separate and remotely located from the rotary transmission selector. The rotary transmission selector is axially moveable along a central axis between a reference position and an axially depressed position. The rotary transmission selector is rotatable about the central axis. However, the rotary transmission selector is only rotatable about the central axis when disposed in the axially depressed position.

Accordingly, because the rotary transmission selector must be depressed into the axially depressed position before the rotary transmission selector may be rotated to select one of the three operating modes, i.e., the neutral mode, the forward drive mode, and the reverse drive mode, the rotary transmission selector limits inadvertent shifts between different operating modes. Additionally, because the park selector is separate and remotely located from the rotary transmission selector, the rotary transmission selector shifts between the neutral mode, the forward drive mode, and the reverse mode. Because the rotary transmission selector shifts between the neutral mode, the forward drive mode, and the reverse drive mode, the rotary transmission selector may be configured to allow shift by feel, thereby allowing an operator to change the operating mode of the transmission without watching the rotary transmission selector.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a mode selection system for a vehicle showing a rotary transmission selector in a reference position.

FIG. 2 is a schematic perspective view of the mode selection system in an axially depressed position for selecting a first operating mode of the transmission.

FIG. 3 is a schematic perspective view of the mode selection system in the axially depressed position and rotated into a first rotational position for selecting a second operating mode of the transmission.

FIG. 4 is a schematic perspective view of the mode selection system in the axially depressed position and rotated into a second rotational position for selecting a third operating mode of the transmission.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a vehicle is generally indicated at 20. The vehicle 20 may include any type and/or style of vehicle 20 that includes a transmission 22, which switches between different operating modes when signaled by an operator. The different operating modes may include, but are not limited to, a neutral mode (shown in the Figures by a first operating mode 34), a forward drive mode (shown in the Figures by a second operating mode 40), a reverse drive mode (shown in the Figures by a third operating mode 36), and a park mode 44.

The park mode 44 locks the transmission 22 to prevent movement of the vehicle 20. The forward drive mode 40 transfers torque from a power source 45, such as an internal combustion engine or an electric motor, to one or more drive wheels, to move the vehicle 20 in a forward direction. Typically, the transmission 22 includes several different gear ratios through which the torque of the power source 45 is transferred, when operating in the forward drive mode 40, to maintain the rotational speed of the power source 45 within an optimal range. The reverse drive mode 36 transfers torque from the power source 45 to one or more drive wheels to move the vehicle 20 in a backward direction, opposite the forward direction provided by the forward drive mode 40. The neutral mode 34 disconnects torque communication between the power source 45 and an output of the transmission 22.

The vehicle 20 includes a mode selection system 24 for switching the transmission 22 between the plurality of different operating modes. The mode selection system 24 is a shift-by-wire system, which includes a controller 26 interconnecting a rotary transmission selector 28 for switching between three different operating modes of the transmission 22, and a park selector 30 for selecting the park mode 44 of the transmission 22. The rotary transmission selector 28 and the park selector 30 signal the controller 26 of the selected operating mode for the transmission 22. The controller 26 then sends a signal to the transmission 22 to cause the transmission 22 to switch to the selected operating mode.

Preferably, the park selector 30 is a push button selector, and is separate and remotely located from the rotary transmission selector 28. Accordingly, depressing the park selector 30 selects the park mode 44 of the transmission 22, and signals the controller 26 to switch the transmission 22 into the park mode 44. The rotary transmission selector 28 is a dial selector. Moving the rotary transmission selector 28 to one of the different, distinct positions selects one of different operating modes of the transmission 22, e.g., the neutral mode 34, the forward drive mode 40, and the reverse drive mode 36. Accordingly, moving the rotary transmission selector 28 into a specific position to select one of the different operating modes of the transmission 22, signals the controller 26 to switch the transmission 22 into the selected operating mode. As shown, the rotary transmission selector 28 is operable to select only three different operating modes, e.g., the forward drive mode, 40, the reverse drive mode 36, and the neutral mode 34. However, it should be appreciated that the rotary transmission selector 28 may be configured to select more than the three exemplary operating modes of the transmission 22. For example, the rotary transmission selector 28 may be configured to select 4, 5 or more different operating modes of the transmission 22.

The rotary transmission selector 28 is axially moveable along a central axis 32 of the rotary transmission selector 28, between a reference position and an axially depressed position. The rotary transmission selector 28 is also rotatable about the central axis 32. However, the rotary transmission selector 28 is only rotatable about the central axis 32 when disposed in the axially depressed position, i.e., when depressed. Accordingly, the rotary transmission selector 28 may only be rotated about the central axis 32 when depressed into the axially depressed position from the reference position. The axially depressed position refers to a depressed axial position of the rotary transmission selector 28 along the central axis 32, regardless of a rotational position of the rotary transmission selector 28 about the central axis 32. The reference position is a default position, to which the rotary transmission selector 28 returns when released. Accordingly, no matter which position the rotary transmission selector 28 is moved to, the rotary transmission selector 28 automatically returns to the reference position. As such, the rotary transmission selector 28 may be referred to as a mono-stable rotary dial.

The rotary transmission selector 28 is moveable to select three different operating modes of the transmission 22. The three different operating modes of the transmission 22 include a first operating mode 34, a second operating mode 40, and a third operating mode 36. The first operating mode 34, the second operating mode 40, and the third operating mode 36 may each include one of the neutral mode, the forward drive mode, and the reverse drive mode.

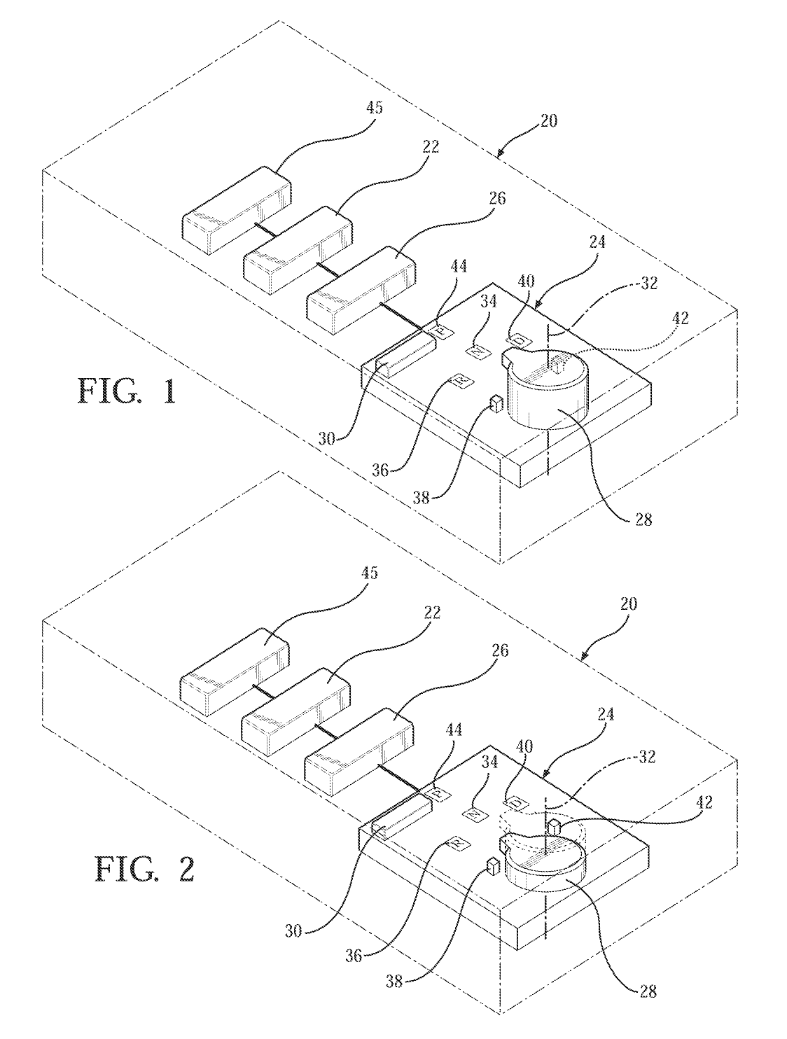

Moving the rotary transmission selector 28 from the reference position, shown in FIG. 1, into the axially depressed position, shown in FIG. 2, without rotating the rotary transmission selector 28 about the central axis 32, selects the first operating mode 34 of the transmission 22.

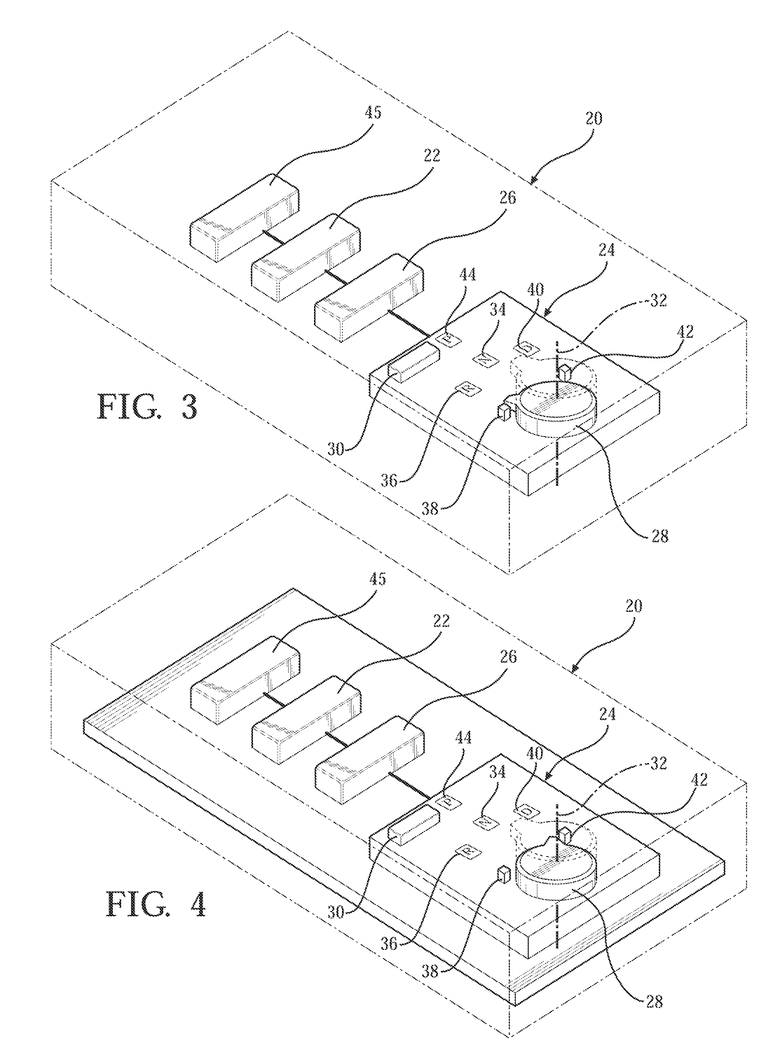

Moving the rotary transmission selector 28 from the reference position, shown in FIG. 1, into the axially depressed position, and rotating the rotary transmission selector 28 counterclockwise to a first rotational position while the rotary transmission selector 28 is in the axially depressed position, shown in FIG. 3, selects the third operating mode 36 of the transmission 22. The vehicle 20 may include a first stop 38 to prevent rotation of the rotary transmission selector 28 beyond the first rotational position. As such, an operator may depress the rotary transmission selector 28 into the axially depressed position, and then rotate the rotary transmission selector 28 counterclockwise until the rotary transmission selector 28 encounters the first stop 38 at the first rotational position to select the third operating mode 36 of the transmission 22. The first stop 38 prevents the rotary transmission selector 28 from rotating any further than the first rotational position.

Moving the rotary transmission selector 28 from the reference position, shown in FIG. 1, into the axially depressed position, and rotating the rotary transmission selector 28 clockwise to a second rotational position while the rotary transmission selector 28 is in the axially depressed position, shown in FIG. 4, selects the second operating mode 40 of the transmission 22. The vehicle 20 may include a second stop 42 to prevent rotation of the rotary transmission selector 28 beyond the second rotational position. As such, an operator may depress the rotary transmission selector 28 into the axially depressed position, and then rotate the rotary transmission selector 28 clockwise until the rotary transmission selector 28 encounters the second stop 42 at the second rotational position to select the second operating mode 40 of the transmission 22. The second stop 42 prevents the rotary transmission selector 28 from rotating any further than the second rotational position.

As noted above, the rotary transmission selector 28 is mono-stable, and automatically returns to the reference position when released. The rotary transmission selector 28 may include any mechanical and/or electronic connections and/or devices necessary to implement the automatic return to the reference position, including but not limited to one or more springs and/or electrical actuators. When the operator selects the first operating mode 34 of the transmission 22, shown in FIG. 2, the rotary transmission selector 28 automatically moves axially along the central axis 32 from the axially depressed position to the reference position, shown in FIG. 1, when released from the axially depressed position, to return to the reference position. When the operator selects the third operating mode 40 of the transmission 22, shown in FIG. 3, the rotary transmission selector 28 automatically rotates clockwise and moves axially along the central axis 32 from the first rotational position to the reference position, shown in FIG. 1, when released from the first rotational position, to return to the reference position. Similarly, when the operator selects the second operating mode 40 of the transmission 22, shown in FIG. 4, the rotary transmission selector 28 automatically rotates counterclockwise and moves axially along the central axis 32 from the second rotational position to the reference position, shown in FIG. 1, when released from the second rotational position, to return to the reference position.

As shown in the Figures, the first operating mode 34 is the neutral mode. One of the second operating mode 40 and the third operating mode 36 is the forward drive mode, and the other of the second operating mode 40 and the third operating mode 36 is the reverse drive mode. As shown in the Figures, the second operating mode 40 is the forward drive mode 40, and the third operating mode is the reverse drive mode 36. However, it should be appreciated that the mode selection system 24 may be configured such that the specific operating modes of the transmission 22, i.e., the neutral mode 34, the forward drive mode, and the reverse drive mode, may be selected moving the rotary transmission selector 28 to a different position than described in the exemplary embodiment above.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A vehicle comprising:
a rotary transmission selector for switching a transmission between a plurality of different operating modes;
wherein the rotary transmission selector is axially moveable along a central axis between a reference position and an axially depressed position;
wherein the rotary transmission selector is rotatable about the central axis; and
wherein the rotary transmission selector is only rotatable about the central axis when disposed in the axially depressed position.

2. The vehicle set forth in claim 1 wherein the rotary transmission selector is moveable to select three different operating modes of the transmission.

3. The vehicle set forth in claim 2 wherein movement of the rotary transmission selector from the reference position into the axially depressed position, without rotating the rotary transmission selector about the central axis, selects a first operating mode of the transmission.

4. The vehicle set forth in claim 3 wherein the rotary transmission selector automatically moves axially along the central axis from the axially depressed position to the reference position, when released from the axially depressed position, to return to the reference position.

5. The vehicle set forth in claim 3 wherein movement of the rotary transmission selector from the reference position into the depressed position, and rotating the rotary transmission selector counterclockwise to a first rotational position while the rotary transmission selector is in the axially depressed position, selects a second operating mode of the transmission.

6. The vehicle set forth in claim 5 wherein the rotary transmission selector automatically rotates clockwise and moves axially along the central axis from the first rotational position to the reference position, when released from the first rotational position, to return to the reference position.

7. The vehicle set forth in claim 3 wherein movement of the rotary transmission selector from the reference position into the depressed position, and rotating the rotary transmission selector clockwise to a second rotational position while the rotary transmission selector is in the axially depressed position, selects a third operating mode of the transmission.

8. The vehicle set forth in claim 7 wherein the rotary transmission selector automatically rotates counterclockwise and moves axially along the central axis from the second rotational position to the reference position, when released from the second rotational position, to return to the reference position.

9. The vehicle set forth in claim 7 wherein the first operating mode, the second operating mode, and the third operating mode include one of a neutral mode, a forward drive mode, and a reverse drive mode.

10. The vehicle set forth in claim 9 wherein the first operating mode is the neutral mode, and wherein one of the second operating mode and the third operating mode is the forward drive mode, and the other of the second operating mode and the third operating mode is the reverse drive mode.

11. The vehicle set forth in claim 10 wherein the second operating mode is the reverse drive mode, and the third operating mode is the forward drive mode.

12. The vehicle set forth in claim 1 further comprising a park selector for selecting a park mode of the transmission.

13. The vehicle set forth in claim 12 wherein the park selector is a push button selector.

14. The vehicle set forth in claim 13 wherein the park selector is separate and remotely located from the rotary transmission selector.

15. A mode selection system for switching between a plurality of different operating modes of a transmission, the mode selection system comprising:
a rotary transmission selector for switching between a neutral mode, a forward drive mode, and a reverse drive mode of the transmission;
a park selector for selecting a park mode of the transmission, wherein the park selector is separate and remotely located from the rotary transmission selector;
wherein the rotary transmission selector is axially moveable along a central axis between a reference position and an axially depressed position;
wherein the rotary transmission selector is rotatable about the central axis; and
wherein the rotary transmission selector is only rotatable about the central axis when disposed in the axially depressed position.

16. The mode selection system set forth in claim 15 wherein movement of the rotary transmission selector from the reference position into the axially depressed position, without rotating the rotary transmission selector about the central axis, selects the neutral mode of the transmission.

17. The mode selection system set forth in claim 16 wherein movement of the rotary transmission selector from the reference position into the depressed position, and rotating the rotary transmission selector counterclockwise to a first rotational position while the rotary transmission selector is in the axially depressed position, selects reverse drive mode of the transmission.

18. The mode selection system set forth in claim 17 wherein movement of the rotary transmission selector from the reference position into the depressed position, and rotating the rotary transmission selector clockwise to a second rotational position while the rotary transmission selector is in the axially depressed position, selects the forward drive mode of the transmission.

19. The mode selection system set forth in claim 18 wherein the rotary transmission selector automatically returns to the reference position when released, such that:
the rotary transmission selector automatically rotates clockwise and moves axially along the central axis from the first rotational position to the reference position, when released from the first rotational position, to return to the reference position;
the rotary transmission selector automatically moves axially along the central axis from the axially depressed position to the reference position, when released from the axially depressed position, to return to the reference position; and
the rotary transmission selector automatically rotates counterclockwise and moves axially along the central axis from the second rotational position to the reference position, when released from the second rotational position, to return to the reference position.

20. The mode selection system set forth in claim 15 wherein the park selector is a push button selector.
